(19) United States
(12) Patent Application Publication
(10) Pub. No.: US 2011/0285186 A1
(43) Pub. Date: Nov. 24, 2011

(54) METHOD FOR AUTOMATICALLY ADJUSTING A SEAT AND USE THEREOF

(75) Inventors: Gerhard Demmelmeier, Ingolstadt (DE); Thomas Enders, Ingolstadt (DE)

(73) Assignee: CONTINENTAL AUTOMOTIVE GMBH, Hannover (DE)

(21) Appl. No.: 13/129,439

(22) PCT Filed: Nov. 11, 2009
(86) PCT No.: PCT/EP2009/064985

§ 371 Date: Aug. 15, 2011

(30) Foreign Application Priority Data
Nov. 18, 2008 (DE) 10 2008 057 861.4

(51) Int. Cl. B60N 2/02; G06F 19/00

(52) U.S. Cl. 297/217.1; 701/49

(57) ABSTRACT

A method for automatically setting a component of a vehicle that can be automatically set, wherein the vehicle has a seat that can be electrically adjusted has the following steps: adjusting (101, 102) the seat (FS) or a seat part (SL) over a specified adjustment travel or adjustment angle, determining (201) the drive load occurring during adjustment of the seat or seat part and calculating a weight value (W) therefrom, comparing (301) the calculated weight value with weight values (W1, W2, . . . , Wm) calculated and stored in advance, setting (401) the component based on the comparison result. The method is used particularly in vehicles having seats that can be electrically adjusted and having vehicle components that can be adapted automatically, e.g., belt tensioner (G), airbag (AB), steering wheel (L), gas, brake, and clutch pedals (P), interior/exterior mirror, and much more.

### CROSS-REFERENCE TO RELATED APPLICATIONS

This application is a U.S. National Stage Application of International Application No. PCT/EP2009/064985 filed Nov. 11, 2009, which designates the United States of America, and claims priority to German Application No. 10 2008 057 861.4 filed Nov. 18, 2008, the contents of which are hereby incorporated by reference in their entirety.

### TECHNICAL FIELD

The present invention relates to a method for automatically setting an automatically settable component of an apparatus having an electrically adjustable seat, in particular an automatically settable component of a vehicle having an electrically adjustable seat.

The method according to the invention is applied, in particular, in vehicles having electrically adjustable seats and automatically adaptable vehicle components such as, for example, the steering wheel, accelerator pedal, brake pedal or clutch pedal, seats with an adjustable backrest, a seat heating system or seat massage system, a headrest, interior mirror or exterior mirror, air conditioning system, stereo system, cruise control device, navigation system or seat belt with an adaptable seat belt pretensioner, an airbag, a headrest, and many more.

### BACKGROUND

For many vehicle models it is possible nowadays to obtain an electric seat adjustment system. Such a seat adjustment system permits the vehicle occupants to store the seat position, once it is set, in a vehicle-side seat control device or in the electronic vehicle key. The stored seat position can then be set automatically by the vehicle occupant by activating a control knob which is arranged in the interior of the vehicle or on the vehicle key. Various seat positions for various vehicle occupants with different body sizes or body weights can also be stored and set again automatically by activating a corresponding control knob. The vehicle occupant can set once in a manual fashion a seat position which suits him by using the electric seat adjustment system, and can store this position through subsequent activation of a corresponding control knob. The vehicle occupant can then automatically set the previously stored seat position when required by simply activating the corresponding control knob.

It is a disadvantage of the abovementioned seat adjustment that the stored seat adjustment can only be set by activating one of the control knobs or the like. The arrangement of the control knobs and of the cabling which electrically connects these control knobs to a corresponding seat control device entails high additional costs and expenditure. In addition, each user of the vehicle must make a note of the control knob assigned to his seat position, wherein for users who do not use the vehicle regularly it is not easy to note the control knob corresponding to their seat position.

In addition, nowadays vehicles are equipped with seat belts and airbags. In the event of an accident, these seat belts and airbags individually adapt the seat belt pretensioning force or firing force of the airbag to the weight of the vehicle occupant located on the seat. For this purpose, a control system uses sensors to measure the weight of the vehicle occupant or the pressure of the vehicle occupant acting on the seat, and adapts the seat belt pretensioning force or firing force of the airbag to the weight of the vehicle occupant or to the pressure. This avoids injuries to vehicle occupants which are caused by, for example, an excessively large explosive swell of the airbag. In addition, on the basis of the sensor data the system detects whether the seat is at all occupied. A disadvantage of the sensor-based seat belt control and airbag control is excessively high costs due to expensive sensors and a high degree of expenditure for installing the sensors in the seat.

Furthermore, more and more vehicles are being equipped with comfort components such as, for example, an electrically adjustable steering wheel, an electrically adjustable accelerator pedal, brake pedal, clutch pedal, electrically adjustable interior/exterior mirror. In some vehicle models, for example two-door convertibles with rear seats, what is referred to as an entry aid (easy entry) is installed. This entry aid facilities entry and exiting of the rear passengers into or out of the vehicle. In order to permit comfortable entry and exiting of the rear passengers, the front seat is automatically adjusted forward or away from the rear seat bench by a predefined adjustment travel. After the rear passengers have got into the vehicle or out of the vehicle, the seat is reset automatically again to the initial adjustment position.

### SUMMARY

According to various embodiments, a method can be provided which primarily permits a more cost-effective and simpler automatic adjustment of a seat. In addition, the seat belt pretensioning force in the case of a seat belt and the firing force of the airbag in the case of an accident can be automatically adapted to the vehicle occupant's weight even without expensive sensors according to various embodiments.

According to an embodiments, a method for automatically setting an automatically settable component of a vehicle having a vehicle seat, may comprise the following method steps:
adjustment of the vehicle seat or of a vehicle seat part from an initial position over a predefined adjustment travel or adjustment angle by means of an adjustment drive of the vehicle seat or vehicle seat part,
measurement of the electrical and/or physical variables of the adjustment drive, occurring during the adjustment of the vehicle seat or vehicle seat part, in order to determine the drive load and calculate a weight value,
comparison of the newly calculated weight value with comparison weight values which are determined and stored in advance, and
setting of the automatically settable component on the basis of the comparison result.

According to a further embodiment, when the newly calculated weight value is within a range, bounded with a respective lower and upper threshold about one of the comparison values which are stored in advance, the component can be set with the setting parameters which have been stored in advance in assignment to this comparison weight value. According to a further embodiment, when the newly calculated weight value is not in any of the ranges, which are bounded by a respective lower and an upper threshold about the comparison weight values which have been stored in advance, manual setting of the component can be brought about by means of a signal, wherein after subsequent manual setting of the component at least one manually newly set setting parameter is stored in assignment to the newly calculated weight value. According to a further embodiment, the electrical and/or physical variables of the adjustment drive which occur during the seat height adjustment, seat longitudinal adjustment, seat transverse adjustment, seat rotational adjustment, seat angle of inclination adjustment, seat base adjustment or seat backrest adjustment can be measured in order to determine the drive load or to calculate the weight value. According to a further embodiment, in order to calculate the weight value, the strength of the current, the voltage, the duration of the supply of power, the temperature or further variables which are necessary to determine the drive load can be measured. According to a further embodiment, insertion of a vehicle key into a key receptacle in the vehicle or subsequent deactivation of the electronic immobilizer of the vehicle or starting of the vehicle engine of the vehicle can bring about the adjustment of the vehicle seat or of the vehicle seat part from the initial position and over the predefined adjustment travel or adjustment angle. According to a further embodiment, when the electronic immobilizer is activated or the vehicle is switched off and the vehicle key is subsequently pulled out of the key receptacle, the vehicle seat or vehicle seat part can be reset again automatically to the initial position before the adjustment. According to a further embodiment, closing can bring about the adjustment of the vehicle seat adjoining this door or of the vehicle seat part thereof from the initial position and over the predefined adjustment travel or adjustment angle. According to a further embodiment, when the door, the vehicle seat or the vehicle seat part thereof which adjoins this door can be reset again automatically to the initial position before the adjustment. According to a further embodiment, the settable component can be the vehicle seat, in particular the driver seat, itself. According to a further embodiment, before the use of the vehicle seat, in particular before the use of the vehicle with this vehicle seat, a seat adjustment can be carried out in the unloaded state of the vehicle seat over the adjustment travel or adjustment angle in an adaptation run, and the weight values which are calculated in the process from the drive load are stored as reference weight values. According to a further embodiment, the functionality and/or ageing of the components of the vehicle seat, in particular difficulty of mechanical movement of the seat mechanism components, can be monitored automatically by comparing the currently calculated weight value with the reference weight value. According to a further embodiment, a seat occupation can be determined automatically by comparing the currently calculated weight value with the reference weight value. According to a further embodiment, the weight of an object located on the vehicle seat, in particular of a person located on the vehicle seat, can be determined by comparing the currently calculated weight value with the reference weight value. According to a further embodiment, failure to put on a seat belt can be detected automatically. According to a further embodiment, the settable component can be the steering wheel, the accelerator pedal, brake pedal or clutch pedal, the seat heating system or seat massage system of a vehicle seat, a headrest, an interior mirror or exterior mirror, the air conditioning system, the cruise control device, or the stereo system of the vehicle. According to a further embodiment, the settable component can be a seat belt or seat belt pretensioner, or an active headrest of the vehicle. According to a further embodiment, the settable component can be a navigation system of the vehicle, wherein in this navigation system automatic destination inputting is carried out on the basis of the current geographic position of the vehicle and the comparison result between the newly calculated weight value and the comparison weight values, which have been stored in advance.

According to another embodiment, an apparatus for automatically setting an automatically settable component of a vehicle having a vehicle seat, in particular according to a method as described above, wherein the device comprises the following features: a control device for adjusting the vehicle seat or a vehicle seat part from an initial position over a predefined adjustment travel or adjustment angle by means of an adjustment drive of the vehicle seat or vehicle seat part, a device for measuring the electrical and/or physical variables of the adjustment drive occurring during the adjustment of the vehicle seat or vehicle seat part, in order to determine the drive load and calculate a weight value, a device for comparing the newly calculated weight value with comparison weight values which have been determined and stored in advance, and a device for setting the automatically settable component on the basis of the comparison result.

According to yet another embodiment, a vehicle may have the following features:
a vehicle seat, an automatically settable component, and
an apparatus as described above for automatically setting the automatically settable component of a vehicle.

### BRIEF DESCRIPTION OF THE DRAWINGS

FIGS. 1 and 2 show, in a schematic illustration, an exemplary embodiment of the method.

FIG. 3 shows in a schematic illustration another exemplary embodiment of the method.

FIGS. 4A and 4B show in a schematic illustration a further embodiment for triggering a weight measurement.

FIG. 5 shows a detailed illustration of an apparatus for automatically setting an automatically settable component of a vehicle with respect to FIGS. 1 and 2.

### DETAILED DESCRIPTION

The various embodiments are based primarily on the recognition that in order to automatically set or adapt the vehicle components to a specific vehicle occupant, the vehicle occupant must firstly have been detected. For example, in order to automatically adapt a seat setting of a seat for a vehicle occupant, it is necessary to firstly detect whether this vehicle occupant is currently located on the seat. Analogously, in order to automatically adapt the seat belt pretensioning force and the firing force of the airbag, the vehicle occupant's weight must firstly be known. The information as to which vehicle occupant is currently located on the seat or information about the vehicle occupant's weight can be derived by detecting a vehicle-occupant-specific feature and subsequently comparing feature with comparison features which are stored in advance. This information is primarily determined according to various embodiments on the basis of the current which is necessary for the electrical adjustment of the seat or of the seat part. In order to adjust the seat or a seat part by a predefined adjustment travel or adjustment angle, electric current is fed to the adjustment drive, or the electric motor, of the seat. This current drives the adjustment drive and moves the seat into the predefined adjustment position. The current which is necessary in this context depends mainly on the load to be moved and on the weight of the seat together with the vehicle occupant located on the seat. Since the weight of the seat does not change per se, the current depends primarily on the weight of the vehicle occupant located on the seat. In the case of a seat which is operated by means of the direct current electric motor, the current which is necessary to move a heavy vehicle occupant or an adult is greater than the current which is necessary to move a relatively lightweight vehicle occupant or a child, for the same adjustment time period. The current can therefore be considered to be a vehicle-occupant-specific feature. At least, it is possible to derive the vehicle occupant's weight from the current.

On the basis of this knowledge, in various embodiments the current which is necessary to adjust the seat or seat part over a predefined adjustment travel or adjustment angle is used as a reference variable for determining the vehicle occupant located on the seat, or the weight of said vehicle occupant.

Since the motor current which is necessary to adjust the seat depends to a greater or lesser extent on the external physical influences, for example the internal temperature of the vehicle or the angle of inclination of the vehicle, further physical variables are also taken into account in addition to the motor current.

Further electrical and physical influences which occur during the adjustment of the seat or seat part, such as the internal temperature of the vehicle or the angle of inclination of the vehicle, and which can be included in the evaluation and determination of the drive load (difficulty of movement of the drive) or the motor load and in the calculation of what is referred to as a weight value, are measured apart from the current values, for example, the voltage and duration of the supply of power.

The term “weight value” does not mean here the value of the bodyweight of a person located on the seat but rather a value or a set of values which is dependent on the bodyweight of the person located on the seat and maps the latter.

The weight values are calculated by a specific SW algorithm. The drive load or motor load serve in this respect as a basis for the calculation. The drive load is determined in turn by the measurement of various variables such as the motor current, motor voltage or, for example, the internal temperature of the vehicle.

A weight value can then be calculated from the currently determined drive load and the already determined drive loads or values for the difficulty of movement of the mechanism. A weight value of zero corresponds, for example, to the drive load only of the seat mechanism and without a person in the seat. A weight value of one corresponds, for example, to the drive load of the seat mechanism and to a person with a body weight of 50 kg who is located on the seat.

The variables which are necessary and which occur at any particular time for the adjustment of the seat or seat part are measured and a weight value is calculated from these variables. The weight value is then compared with comparison values which have been measured and stored in advance. In this context, the variation of the vehicle occupant's weight as a result, for example, of the change in the weight of the clothes being worn and subsequent changes in measured variables are also included. Each comparison weight value is therefore assigned a lower threshold and an upper threshold. If the present weight value lies within a range about a comparison weight value which is bounded by means of these two thresholds, the vehicle occupant is considered to be unambiguously detected by means of this comparison weight value. After the detection of which vehicle occupant is located on the seat, the setting parameters which have been set manually in advance and are stored in assignment to this comparison weight value are read out and the vehicle components are set by means of these setting parameters.

If the present weight value does not lie in any of the ranges about the comparison weight values or if the present weight value does not correspond to any of the comparison weight values with a deviation of the abovementioned thresholds, the vehicle occupant is considered to have been detected as a new vehicle user. In this case, manual setting of the vehicle component is brought about by means of a signal. It is possible to use an acoustic, optical and/or haptic signal here.

If the vehicle occupant follows the signal and sets the vehicle components manually, the manually set parameters are then stored automatically or by subsequent manual activation of a knob, arranged, for example, on the center console, together with the weight value which has just been determined, or in assignment to this weight value. This newly stored weight value then serves as a further comparison weight value for subsequent automatic setting processes of the vehicle component, and the parameters which are stored in assignment to this weight value are then used as further setting parameters.

The electrical and/or physical variables which are necessary or which occur during the seat height adjustment, seat longitudinal adjustment, seat transverse adjustment, seat rotational adjustment, seat angle of inclination adjustment, seat base adjustment or seat backrest adjustment are measured for as long as the different body weights of the vehicle occupants can be determined from these weight values. The settable components according to various embodiments include seats themselves or seat components such as, for example, a seat backrest, seat heating system or seat massage system, steering wheel, accelerator pedal, brake pedal or clutch pedal, a headrest, interior mirror or exterior mirror, air conditioning system, stereo system, cruise control device, navigation system, seat belt with adaptive seat belt pretensioner, airbag and many more.

Stated in a summarized and simplified form, the method according to various embodiments is characterized by the following method steps: adjustment of the seat or of a seat part over a predefined adjustment travel or adjustment angle, measurement of the drive load which is necessary to adjust the seat or seat part, by acquiring measurement variables such as strength of the current, voltage, duration of the power supply and further variables such as the temperature of the vehicle passenger compartment or angle of inclination of the vehicle, calculation of the weight value on the basis of the current values and further variables, comparison of the calculated weight value with comparison weight values which have been measured and stored in advance, and setting of the component on the basis of the comparison result.

The measurable values include the strength of current, voltage, duration of the power supply and/or further variables, for example the temperature of the vehicle passenger compartment or angle of inclination of the vehicle, which can be used to evaluate and determine the drive load or motor load and can be included in the calculation of what is referred to as a weight value.

The adjustment of the seat or a seat part from the initial position over the predefined adjustment travel or adjustment angle is preferably brought about by inserting the vehicle key into the key receptacle and/or subsequent deactivation of the electronic immobilizer or starting of the vehicle engine of the vehicle. Alternatively, the adjustment of the seat or of a seat part is brought about by closing the door which adjoins this seat. When the electronic immobilizer is activated or a vehicle engine is switched off and the vehicle key is subsequently pulled out of the key receptacle, the seat or seat part is reset again automatically to the initial position before the adjustment, so that when the vehicle is used next the seat or seat part can be moved back over the adjustment travel and can in the process supply the new current value.

In a similar way, when the door opens the seat or seat part thereof which adjoins this door can be reset again automatically to the initial position before the adjustment.

The seats are constructed and the adjustment travel and/or adjustment angle of the seat predefined in such a way that no body parts of the vehicle occupants or other parts can become stuck in the vehicle between the approaching seats or seat parts and of the vehicle parts.

Before the use of the seat, in particular before the use of the motor vehicle having the seat, a seat adjustment is advantageously carried out in the unloaded state of the seat over the abovementioned predefined adjustment travel or adjustment angle in an adaptation run, and in the process the variables mentioned above are measured and reference weight values are calculated on the basis of these measured measurement variables. The reference weight values are then stored in a memory and compared during the setting of the components according to various embodiments with the present weight value calculated during the adjustment of the seat or seat part.

These reference weight variables allow the application possibilities of the method according to various embodiments to be expanded. The occupation of the seat or weight of the vehicle occupant located on the seat can primarily be determined automatically by comparing the present weight value with the reference weight values. If the currently calculated weight value lies near to a reference weight value, or if the present weight value is the same as a reference weight value with a deviation which is less than a predefined threshold, it is defined that this seat is not occupied. Failure to put on the seat belt is determined from the seat occupation information. The expensive seat occupation sensors can therefore be eliminated.

In addition, the functionality or ageing of the components of the seat, in particular difficulty of mechanical movement of the seat mechanism components can be monitored automatically by comparing the present weight value with the reference weight values. The algorithms which are known from the limitation of the excess force can be used in this process. Such an algorithm is described in German Laid-Open patent application WO 2002 006 615 A2.

In order to monitor the functionality or the ageing of the components of the seat, in particular the difficulty of mechanical movement of the seat mechanism components, the deviation between the present weight value and the reference weight values continues to be evaluated. If the deviation is too large, on condition that this deviation continues to be smaller than the predefined threshold, and/or the deviations during past comparison processes become larger and larger, ageing or difficulty of movement of the seat components is detected and, if appropriate, counter measures are initiated.

Since the current necessary to adjust the seat or seat part depends on the weight of the vehicle occupant who is located on the seat, the weight value is determined mainly by the current value, and the weight of the vehicle occupant can then easily be determined from the present weight value and the reference weight value.

The abovementioned thresholds can be determined in advance or after the vehicle has been completely manufactured. For this purpose, a series of measurement with different weightings are carried out on the seat and the thresholds are determined on the basis of the data measured in the process.

If the settable component is a navigation system of a vehicle, automatic destination inputting can be carried out on the basis of the current geographic position of the vehicle and the comparison result between the present weight value and the comparison weight values which have been stored in advance. The vehicle occupant manually inputs a destination location or working location at a specific starting location or living location into the navigation system and subsequently stores this destination together with the geographic position of the currently located starting location and the present weight value by actuating the control knob. During subsequent use of the vehicle at the starting location, specifically the living location, the driver can firstly be detected by comparing the weight values and the destination, particularly the working location, can then be called up on the basis of the geographic position of the starting location.

According to a further aspect of various embodiments, an apparatus for automatically setting an automatically settable component of a vehicle having a vehicle seat is provided, which apparatus is suitable, in particular, for carrying out a method as described above. In the context, the apparatus has a control device for adjusting the vehicle seat or a vehicle seat part from an initial position over a predefined adjustment travel or adjustment angle by means of an adjustment drive of the vehicle seat or vehicle seat part. In addition, said apparatus has a device for measuring the electrical and/or physical variables of the adjustment drive occurring during the adjustment of the vehicle seat or vehicle seat part, in order to determine the drive load and calculate a weight value. Moreover, the apparatus has a device for comparing the newly calculated weight value with comparison weight values which have been determined and stored in advance. Furthermore, a device is provided for setting the automatically settable component on the basis of the comparison result.

Finally, according to a further aspect of various embodiments, a vehicle is provided which has a vehicle seat, an automatically settable component and an abovementioned apparatus for automatically setting the automatically settable component of a vehicle.

Advantageous refinements of the abovementioned method for automatically setting an automatically settable component are, insofar as they can be transferred to the apparatus for automatically setting an automatically settable component, also to be considered advantageous refinements of the apparatus.

In the text which follows, the method according to various embodiments will be explained in more detail on the basis of exemplary embodiments with the aid of figures. In this context, the method according to various embodiments will be described for the purpose of better illustration in two exemplary embodiments, wherein
the first exemplary embodiment describes setting of the vehicle components which can be set at the vehicle occupant's request—in other words, the setting of these vehicle components can be influenced actively by the vehicle occupant—when such components include seats or seat parts such as, for example, the seat backrest, seat massage system, seat heating system, steering wheel, headrest, accelerator pedal, clutch pedal and brake pedal, interior mirror/exterior mirror, stereo system, air conditioning system, navigation system, cruise control device and
the second exemplary embodiment describes the setting of the vehicle components which cannot be set at the vehicle occupant's request, but are rather system-controlled—in other words the setting of these vehicle components cannot be influenced by the vehicle occupant—vehicle component such as airbags, an active headrest, seat belt or seat belt pretensioner.

These two exemplary embodiments also do not mean that by means of the method just one of the two groups of vehicle components, specifically a group of vehicle components which can be set under the active influence of the vehicle occupant and a group of vehicle components which can be set under control by a system, can be set, but rather they serve merely for relatively simple illustration of the setting of the two groups of vehicle components. The settings according to various embodiments of the two groups of components are preferably carried out simultaneously.

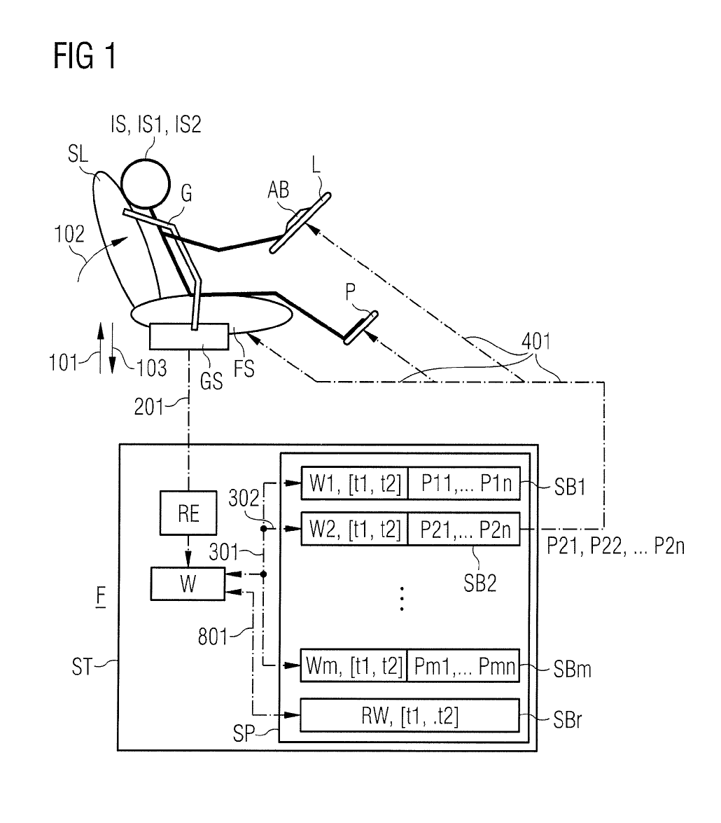

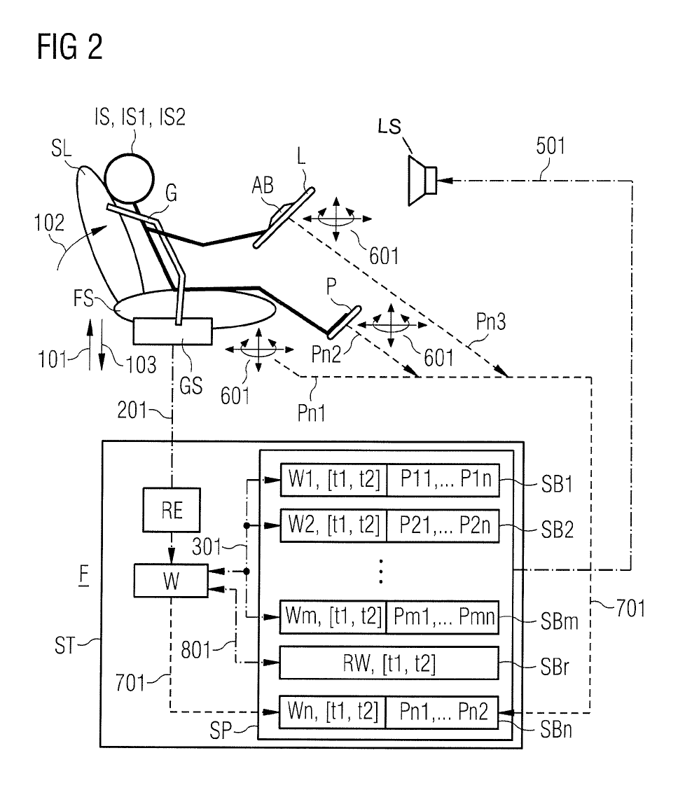

FIGS. 1 and 2 show, in a schematic illustration, an exemplary embodiment of the method for automatically setting the vehicle components such as seat parts, such as for example a seat backrest, seat massage system, seat heating system, steering wheel, accelerator pedal, clutch pedal and brake pedal, interior/exterior mirror, stereo system, air conditioning system, navigation system, cruise control device of a vehicle F with a driver seat FS (Also representative of a general vehicle seat, such as a passenger's seat S), wherein for the sake of better clarity just one driver's seat FS with a pivotable seat backrest SL, steering wheel L and accelerator pedal P are illustrated in the figures. The setting of other components according to various embodiments such as a seat massage system, seat heating system, interior mirror/exterior mirror, stereo system, air conditioning system, navigation system, cruise control device is carried out in a similar way or will be explained in more detail at the end of the description of the figures.

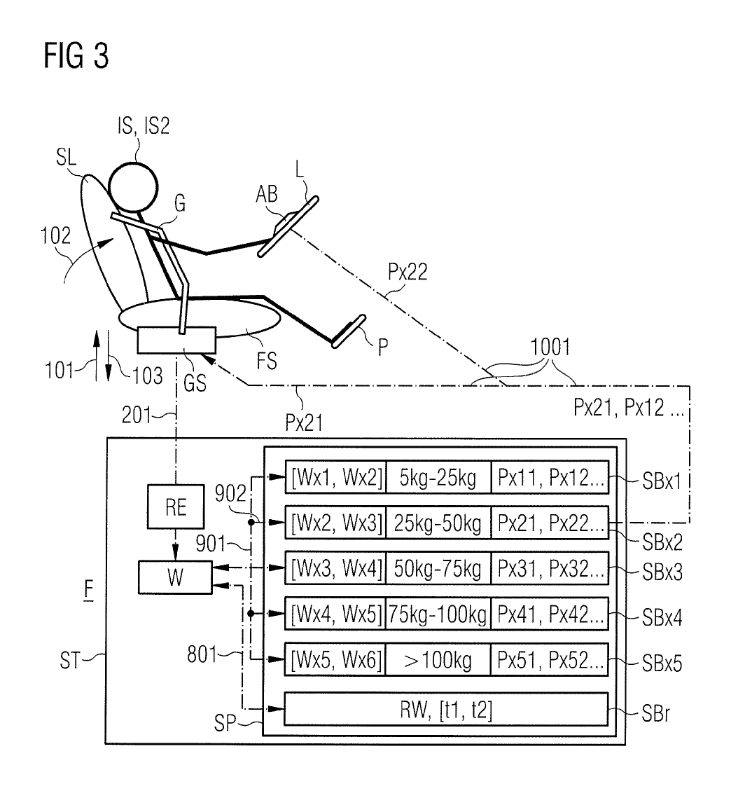

FIG. 3 shows in a schematic illustration an exemplary embodiment of the method for automatically setting the safety-related vehicle components such as airbags, active headrest, seat belt pretensioner of a vehicle F with a driver's seat FS, wherein for the sake of better clarity only an airbag AB which is integrated into the steering wheel L and the seat belt G together with the seat belt pretensioner GS are illustrated on the driver's seat FS in the figure. The setting according to various embodiments of other safety-related components such as an active headrest takes place in a similar way.

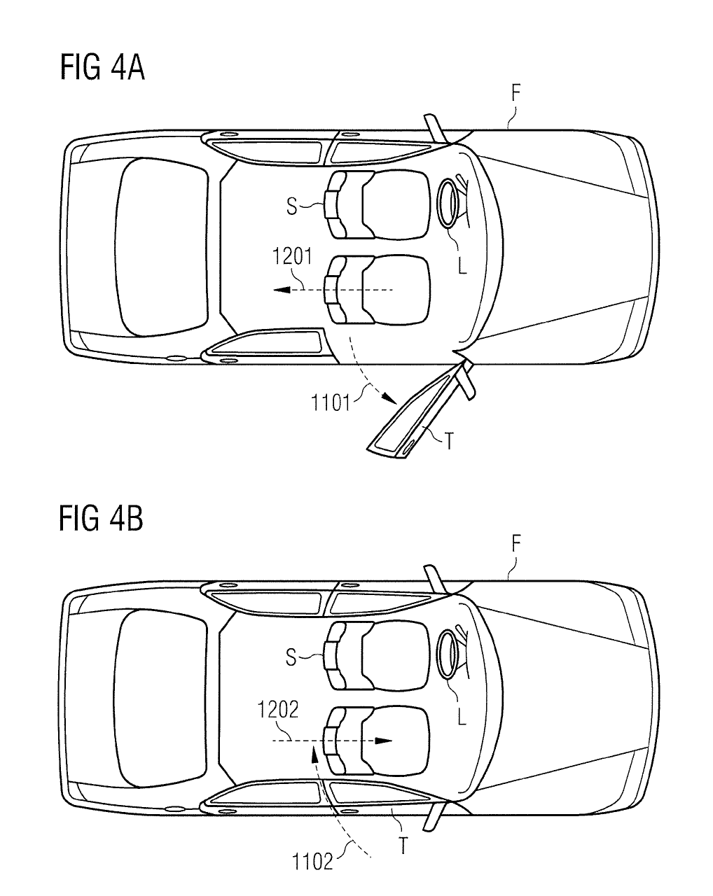

FIGS. 4A and 4B show in a schematic illustration a further embodiment for triggering a weight measurement for the automatic setting of a settable component.

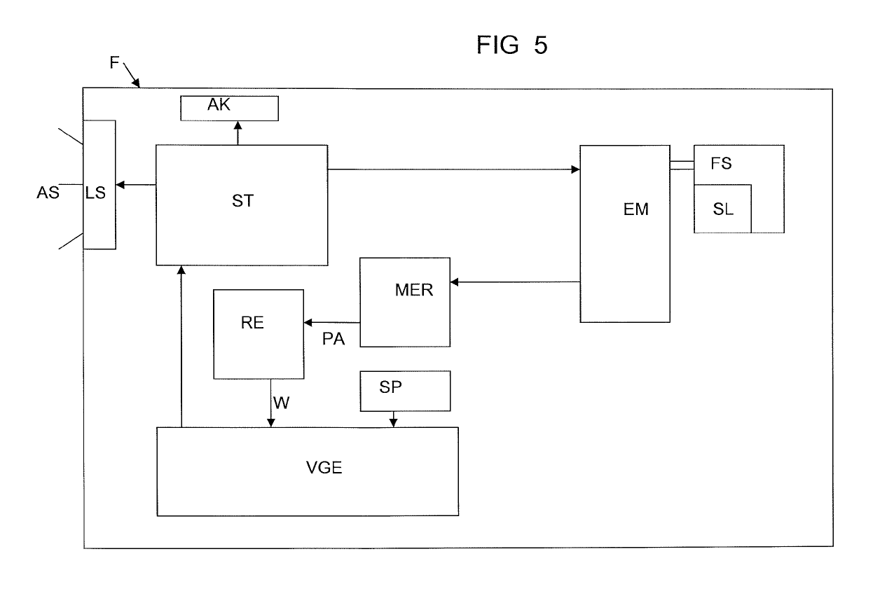

FIG. 5 shows a detailed illustration of an apparatus for automatically setting an automatically settable component of a vehicle with respect to FIGS. 1 and 2.

The vehicle F has, according FIGS. 1 and 2, a settable vehicle seat FS with a pivotable seat backrest SL, a settable steering wheel L with an integrated airbag AB, a settable accelerator pedal P, and a seat belt G with an automatic seat belt pretensioner GS. The vehicle components FS, SL, L, P are set according to various embodiments as follows.

Preferably, a new vehicle F has been acquired, the vehicle users and/or vehicle occupants IS, IS1, IS2 respectively set the vehicle components, for example driver's seat FS, seat backrest SL, steering wheel L, accelerator pedal P and further settable vehicle components which are not illustrated in more detail in the two FIGS. 1 and 2, such as an interior/exterior mirror, stereo system, headrest, air conditioning system, seat heating system, in such a way that the position values or setting values of the vehicle components which are set match or please the respective vehicle user IS1, IS2.

For example, the first vehicle user IS1 sets the steering wheel L and the accelerator pedal P higher, respectively to a position value P11 and P12, the stereo system to a quieter setting and the seat heating system on the driver's seat FS to 25 degrees. In contrast, the second vehicle user IS2 sets the steering wheel L and the accelerator pedal P to a lower setting, respectively to a position value P21, P22, and the stereo system to a louder setting and the seat heating system on the driver's seat FS to twenty degrees. In addition, the two vehicle users IS1 and IS2 respectively set the driver's seat FS to a position IS1 or IS2 which suits him. For example, the first vehicle user IS1 sets the driver's seat FS near to the steering wheel L to a position value P1n, and the second vehicle user IS2 sets the driver's seat FS remote from the steering wheel L to a position value P2n. The first and second vehicle users IS1 and IS2, respectively, then press a knob in the interior of the vehicle and cause all the set values P11, P12, P1n and P21, P22, P2n of the vehicle components FS, L, P, including the created position of the driver's seat FS to be respectively stored in a memory unit SP of the control device ST in the vehicle F. Directly before the storage of the values P11, P12, P1n and P21, P22, P2n, respectively, the driver's seat FS is, according to various embodiments, moved 101 vertically upward over a predefined adjustment travel under the automatic control of the control device S2. The current values which are necessary here and the further values such as the internal temperature of the vehicle or angle of inclination of the vehicle etc. are measured by the control device ST. A computational device RE in the control device ST calculates on the basis of the measured values, the weight values W1 and W2 and stores these values W1 and W2 with the previously set setting values P11, P12, P1n and P21, P22, P2n of the vehicle components FS, L, P together in the memory unit SP, when the weight value W1 of the first vehicle user IS1 is stored together with values P11, P12, P1n which have been set by this vehicle user IS1 in a first memory block SP1, or the weight value W2 of the second vehicle user IS2 is stored together with values P21, P22, P2n which have been set by this vehicle user IS2 in a second memory block SP2. The stored weight values W1, W2 then serve during the subsequent normal operation of a vehicle as comparison weight values. During subsequent use of this vehicle F, these stored data W1, P11, P12, P1n and W2, P21, P22, P2n are called up repeatedly and used for automatic setting of the vehicle components FS, L, P.

The automatic setting of the vehicle components FS, L, P is carried out according to various embodiments as follows (the functional relationship between individual components which are mentioned below is shown in FIG. 5 here): when the vehicle key is inserted into the key receptacle and the electronic immobilizer is subsequently deactivated or the vehicle engine is started by the vehicle occupant on the driver's seat FS, the driver's seat FS is preferably moved vertically upward from an initial position over the abovementioned adjustment travel (upward arrow) under automatic control by the control device ST and preferably by means of an electric motor EM (as the adjustment drive) according to step 101. In the process, the abovementioned values for current, internal temperature of the vehicle and angle of inclination of the vehicle are measured as parameters PA by a measuring device MER (according to step 201), and a weight value W is calculated by the computing unit RE and on the basis of the measured values. The newly calculated weight value W is also compared with weight values and comparison weight values W1, W2, . . . , Wm which are stored in advance in the memory unit SP as well as with a reference weight value RW
a description is given in the following text of the reference weight value RW and the value range [Rw−t1, RW+t2] around this reference weight value RW—by comparison device VGE. In the process it is tested whether this new weight value W with a deviation from a predefined lower threshold t1 and an upper threshold t2 is the same as one of the stored comparison weight values W1, W2, . . . , Wm or the reference weight value RW. In other words: it is tested whether the new weight value W lies in one of the value ranges: [W1−t1, W1+t2], [W2−t1, W2+t2], . . . , [Wm−t1, Wm+t2], [RW−t1, RW+t2], bounded by the lower and upper thresholds t1 and t2, around the stored comparison weight values W1, W2, . . . , Wm and the reference weight value RW.

If, for example, the new weight value W lies within the value range [W2−t1, W2+t2] around the comparison weight value W2 302, the vehicle occupant IS is identified as the vehicle user IS2, and the vehicle components, in particular the driver's seat FS, the steering wheel L, the accelerator pedal P are set automatically to the stored (position) values P11, P12, P1n which have been previously set and assigned to comparison weight value W2, according to step 401, by virtue of the fact that, for example, the comparison device VGE communicates the result of the comparison (specifically the value W2) to the control device ST and the latter then actuates the electric motor EM (for the components FS and SL) or other components AK, such as the components S, L, P, G, GS, AB, etc.

If the new weight value W does not lie in any of the ranges, bounded by the lower and upper threshold t1, t2, around the stored comparison weight values W1, W2, . . . , Wm, and the reference weight value RW, and/or if the new weight value W does not lie in any of the value ranges: [W1−t1, W1+t2], [W2−t1, W2+t2], . . . , [Wm−t1, Wm+t2], [RW−t1), RW+t2], the control device ST alerts (after receiving a corresponding “negative” comparison result) the vehicle occupant IS to a manual setting (in a subsequent step 601) of the components: driver's seat FS, steering wheel L, accelerator pedal P, by means of, for example, an acoustic signal AS via a loudspeaker LS according to step 501. If the vehicle occupant IS follows this signal AS and sets the components FS, L, P manually to new (position) values Pn1, Pn2, Pn3 (according to step 601) and subsequently presses a knob to store the (position) values Pn1, Pn2, Pn3, the control apparatus ST stores these new setting values Pn1, Pn2, Pn3 in assignment to the previously measured new weight value W in a new memory block SBn of the memory unit SP (according to step 701). During subsequent use of the vehicle F, the newly stored weight value W is then considered to be a further comparison weight value Wn for the newly stored (position) values Pn1, Pn2, Pn3.

When the electronic immobilizer is actuated or the vehicle engine is switched off and the vehicle key is subsequently pulled out of the key receptacle, the driver's seat FS is reset again automatically to the initial position before the adjustment travel is executed (according to the downward arrow in step 103), with the result that when the vehicle F is next used this driver's seat FS is moved again over the adjustment travel (according to step 101) and in the process it can supply new measurement data for a new weight value W according to step 201.

However, in order to automatically set the front passenger's seat or rear seat S it is possible that the seat S is not occupied, directly after the installation of the seat FS, S in the vehicle F, in particular directly after the assembly of the vehicle F with the seats FS, S, a seat adjustment 101 is carried out in the unloaded state of the seat FS, S in an adaptation run under various ambient conditions, for example at various internal temperatures of the vehicle, angles of inclination of the vehicle etc. The abovementioned reference weight values RW are calculated from the values measured here, including the strength of the current, voltage, duration of the power supply, internal temperature of the vehicle, angle of inclination of the vehicle etc., and are stored in a memory block SBr of the memory unit SP.

When the vehicle F is subsequently used, the currently calculated weight values W are compared with the reference weight values RW according to step 801. If the present weight value W corresponds under the similar ambient conditions such as temperature or angle of inclination to the corresponding reference weight value RW with a deviation of less than thresholds t1 and t2, or if the weight value W lies in the value range [RW−t1, RW+t2], the seat S is considered to be unoccupied. As a result, automatic detection of the occupation of the seat can be carried out using the method according to various embodiments.

In addition, the functionality or ageing of the components of the seats FS, S, in particular the difficulty of mechanical movement of the seat mechanism components, is monitored automatically by comparing (according to step 801) the currently measured weight value W with the reference weight value RW. If the currently measured weight value W lies within the value range [RW−t1, RW+t2], around the reference weight value RW, but differs from the reference weight value RW to a high degree or if the currently measured weight value W has, compared to the weight value W measured earlier, an ever larger deviation from the reference weight value RW within the value range [RW−t1, RW+t2], a functionality fault or ageing of the components of the seat FS, S, in particular difficulty of mechanical movement of the seat mechanism components, is occurring.

By comparison (according to step 801) of the present weight value W with the reference weight value RW and by subsequent calculation, the weight of the vehicle occupant IS, IS1, IS2 located on the seat FS, S can be determined.

The thresholds t1, t2 are preferably also measured and determined in the abovementioned adaptation run for the measurement of the reference weight value RW. The thresholds t1, t2 can be absolute values or else relative values for the respective comparison weight value W1, W2, . . . , Wm, Wn or reference weight value RW. For example, the two thresholds t1, t2 each have a value of 5% of the respective comparison weight value W1, W2, . . . , Wm, Wn or reference weight value RW.

FIG. 3 shows, in a schematic illustration, an exemplary embodiment of the method for automatically setting the safety-related vehicle components such as airbags, an active headrest, seat belt pretensioner of a vehicle F with a driver's seat FS, wherein in the figure only an airbag AB and a seat belt G on the driver's seat FS are illustrated for the sake of better clarity. Other safety-relevant components such as the active headrest are set according to various embodiments in a similar way.

The vehicle F has, according to FIG. 3, inter alia a settable driver's seat FS with an adaptive seat belt G together with the seat belt pretensioner GS, an adaptive airbag AB integrated into the steering wheel L. In the case of an accident, in particular a head-on crash, the seat belt pretensioner GS adapts the belt force to the weight or the weight class of the vehicle occupant who is located on the seat. In an analogous fashion, the airbag firing device which is integrated in the airbag AB adapts the firing force of the airbag AB to the weight of the vehicle occupant in the event of an accident. For this purpose, the weight of the vehicle occupant or more information as to which weight class the vehicle occupant belongs to is necessary. This information is determined according to various embodiments as follows:

Directly after the assembly of the vehicle F, preferably during the abovementioned adaptation run, the vehicle seats FS, S are moved 101 controlled vertically upward with different weights on the seat face over the abovementioned adjustment travel. The current values which are necessary in the process are measured under various ambient conditions such as internal temperature of the vehicle, angle of inclination of the vehicle etc. Weight values are calculated from the measured values. These weight values are then assigned to the respective weight or stored divided up into weight classes in the memory unit SP of the control device ST. For example, the weight values Wx1 to Wx2 for a weight of 5 to 25 kg arranged on the seat FS, S are stored, together with a seat belt pretensioning force of Px11 and an airbag firing force Px12, in a memory block SBx1 of the memory unit SP. The seat belt pretensioning force Px11 or airbag firing force Px12 is determined in advance, for example by means of crash tests. In an analogous fashion, weight values are determined for a weight of 25 kg to 50 kg and the weight values Wx2, Wx3 which are determined are stored, together with the force values Px21, Px22, . . . applicable to this weight class 25 kg to 50 kg, for the seat belt pretensioner GS and airbag AB, in another memory block SBx2.

When the vehicle F is subsequently used, in particular in the case of accidents, according to various embodiments the seat belt pretensioning force or airbag firing force is adapted automatically to the weight or the weight class of the vehicle occupant IS, IS1, IS2. This takes place as follows:

As in the previous exemplary embodiment, when the vehicle key is inserted into the key receptacle and the electronic immobilizer is subsequent deactivated or the vehicle engine is started by the vehicle occupant IS on the driver's seat FS, the driver's seat FS is preferably moved vertically upward from the initial position over the abovementioned adjustment travel under automatic control by the control device ST (according to step 101). In the process, the necessary current value and also further values such as the voltage or the duration of the power supply etc. are measured (according to step 201) and a weight value W is newly calculated from the measured values. Then it is subsequently tested whether the new weight value W lies in one of the value ranges: [Wx1, Wx2], [Wx2, Wx3], . . . , [Wx5, Wx6]; [RW−t1, RW+t2] according to steps 901, 801).

If the weight value W lies, for example, within the value range [Wx2, Wx3] (cf. step 902), it is detected that the vehicle occupant IS belongs to the weight class 25 kg to 50 kg. The seat belt pretensioner GS then adapts the seat belt force necessary in the event of an accident to the value Px21 and/or the airbag AB adapts the necessary airbag firing force to the value Px22 (according to step 1001). Since the comparison weight values Wx1, . . . , Wx6 cover all the possible weights of 5 kg to over 100 kg, it would generally not be the case that the weight value W in the case of a seat FS, S with a vehicle occupant lies outside the value ranges Wx1 to Wx6. However, if the weight value W is below the value Wx1, it is the case that the seat is not occupied.

In previous exemplary embodiments, the measurements of the current value or of further relevant values in the calculation of weight value W is brought about by the insertion of the vehicle key into the key receptacle and subsequent deactivation of the electronic immobilizer or starting of the vehicle engine by the vehicle occupant IS on the driver's seat FS.

Alternatively, the measurement of the relevant values or the calculation of the weight value W in the case of a seat S can be brought about by closing 1102 of the vehicle door T which adjoins this seat S, as is illustrated in FIGS. 4A and 4B. In this context, the entry/exiting aid function (easy entry) which is present can be used.

In the case of opening (according to step 1101) of the vehicle door T, the seat S which adjoins this door T is adjusted automatically in the rearward direction over a predefined adjustment travel (according to step 1201). In the case of closing (according to step 1102) of the vehicle door T, after the vehicle occupant IS has entered the vehicle F the seat S resets 1202 again automatically in the forward direction to the initial position. The current value which occurs for the resetting (according to step 1202) of the seat S together with the vehicle occupant IS who is located on the seat S as well as further values are measured and the weight value W is calculated from these values.

With respect to the illustration in FIG. 5 it is to be noted that although all the components described above are illustrated individually, they can also be integrated partially into a component. In this respect it is possible, for example, that the measuring device MER, the computing device RE, the comparison device VGE and the memory device SP can all be combined and/or integrated in the control device (as indicated by the dashed border).

### LIST OF REFERENCE SYMBOLS

F Vehicle
FS, S Driver's seat, vehicle seat
SL Seat backrest
L Steering wheel
P Accelerator pedal, brake pedal or clutch pedal
G Seat belt
GS Seat belt pretensioner
AB Airbag
T Vehicle door
AS Acoustic signal
IS, IS1, IS2 Vehicle user, vehicle occupant
ST Control device
SP Memory unit
SB1, SB2, SB3,
SBm, SBn, SBx1,
SBx2, SBx3,
SBx4, SBx5 SBr Memory block
EM Electric motor
VGE Comparison device
LS Loudspeaker
MER Measuring device
AK Other components (such as L, P, . . . )
RE Computing unit

What is claimed is:

1. A method for automatically setting an automatically settable component of a vehicle having a vehicle seat, comprising the following method steps:
adjustment of the vehicle seat or of a vehicle seat part from an initial position over a predefined adjustment travel or adjustment angle by means of an adjustment drive of the vehicle seat or vehicle seat part,
measurement of at least one of the electrical and the physical variables of the adjustment drive, occurring during the adjustment of the vehicle seat or vehicle seat part, in order to determine the drive load and calculate a weight value,
comparison of the newly calculated weight value with comparison weight values which are determined and stored in advance, and
setting of the automatically settable component on the basis of the comparison result.

2. The method according to claim 1, wherein when the newly calculated weight value is within a range, bounded with a respective lower and upper threshold about one of the comparison values which are stored in advance, the component is set with the setting parameters which have been stored in advance in assignment to this comparison weight value.

3. The method according to claim 1, wherein when the newly calculated weight value is not in any of the ranges, which are bounded by a respective lower and an upper threshold about the comparison weight values which have been stored in advance, manual setting of the component is brought about by means of a signal, wherein after subsequent manual setting of the component at least one manually newly set setting parameter is stored in assignment to the newly calculated weight value.

4. The method according to claim 1, wherein the at least one of electrical and physical variables of the adjustment drive which occur during the seat height adjustment, seat longitudinal adjustment, seat transverse adjustment, seat rotational adjustment, seat angle of inclination adjustment, seat base adjustment or seat backrest adjustment are measured in order to determine the drive load or to calculate the weight value.

5. The method according to claim 1, wherein in order to calculate the weight value, the strength of the current, the voltage, the duration of the supply of power, the temperature or further variables which are necessary to determine the drive load are measured.

6. The method according to claim 1, wherein insertion of a vehicle key into a key receptacle in the vehicle or subsequent deactivation of the electronic immobilizer of the vehicle or starting of the vehicle engine of the vehicle brings about the adjustment of the vehicle seat or of the vehicle seat part from the initial position and over the predefined adjustment travel or adjustment angle.

7. The method according to claim 6, wherein when the electronic immobilizer is activated or the vehicle is switched off and the vehicle key is subsequently pulled out of the key receptacle, the vehicle seat or vehicle seat part is reset again automatically to the initial position before the adjustment.

8. The method according to claim 1, wherein closing brings about the adjustment of the vehicle seat adjoining this door or of the vehicle seat part thereof from the initial position and over the predefined adjustment travel or adjustment angle.

9. The method according to claim 8, wherein when the door, the vehicle seat or the vehicle seat part thereof which adjoins this door is reset again automatically to the initial position before the adjustment.

10. The method according to claim 1, wherein the settable component is the vehicle seat or the driver seat, itself.

11. The method according to claim 10, wherein before the use of the vehicle seat,
or before the use of the vehicle with this vehicle seat, a seat adjustment is carried out in the unloaded state of the vehicle seat over the adjustment travel or adjustment angle in an adaptation run, and the weight values which are calculated in the process from the drive load are stored as reference weight values.

12. The method according to claim 11, wherein at least one of the functionality and ageing of the components of the vehicle seat or difficulty of mechanical movement of the seat mechanism components, are monitored automatically by comparing the currently calculated weight value with the reference weight value.

13. The method according to claim 11, wherein a seat occupation is determined automatically by comparing the currently calculated weight value with the reference weight value.

14. The method according to claim 11, wherein the weight of an object located on the vehicle seat or of a person located on the vehicle seat, is determined by comparing the currently calculated weight value with the reference weight value.

15. The method according to claim 13, wherein failure to put on a seat belt is detected automatically.

16. The method according to claim 1, wherein the settable component is the steering wheel, the accelerator pedal, brake pedal or clutch pedal, the seat heating system or seat massage system of a vehicle seat, a headrest, an interior mirror or exterior mirror, the air conditioning system, the cruise control device, or the stereo system of the vehicle.

17. The method according to claim 1, wherein the settable component is a seat belt or seat belt pretensioner, or an active headrest of the vehicle.

18. The method according to claim 1, wherein the settable component is a navigation system of the vehicle, wherein in this navigation system automatic destination inputting is carried out on the basis of the current geographic position of the vehicle and the comparison result between the newly calculated weight value and the comparison weight values, which have been stored in advance.

19. An apparatus for automatically setting an automatically settable component of a vehicle having a vehicle seat, wherein the device comprises the following features:
a control device for adjusting the vehicle seat or a vehicle seat part from an initial position over a predefined adjustment travel or adjustment angle by means of an adjustment drive of the vehicle seat or vehicle seat part,
a device for measuring at least one of the electrical and physical variables of the adjustment drive occurring during the adjustment of the vehicle seat or vehicle seat part, in order to determine the drive load and calculate a weight value,
a device for comparing the newly calculated weight value with comparison weight values which have been determined and stored in advance, and
a device for setting the automatically settable component on the basis of the comparison result.

20. A vehicle comprising:
a vehicle seat,
an automatically settable component,
an apparatus according to claim 19 for automatically setting the automatically settable component of a vehicle.
